(19) United States
(12) Patent Application Publication
(10) Pub. No.: US 2024/0372180 A1
(43) Pub. Date: Nov. 7, 2024

(54) FIBER COMPOSITE COMPONENT

(71) Applicant: SGL CARBON SE, Wiesbaden (DE)

(72) Inventors: Juergen JOOS, Meitingen (DE); Bernd WOHLETZ, Meitingen (DE); Patrick BERGER, Meitingen (DE); Christian SCHLUDI, Meitingen (DE); Anna HAMMELMEIR, Meitingen (DE); Christoph EBEL, Meitingen (DE); Dominik KAISER, Ried im Innkreis (AT); Jonas SAUER, Ried im Innkreis (AT)

(73) Assignee: SGL CARBON SE, Wiesbaden (DE)

(21) Appl. No.: 18/293,512

(22) PCT Filed: Jul. 28, 2022
(86) PCT No.: PCT/EP2022/071269

§ 371 Date: Jan. 30, 2024

Related U.S. Application Data
(60) Provisional application No. 63/227,734, filed on Jul. 30, 2021.

(51) Int. Cl. H01M 50/128; H01M 10/48; H01M 50/117

(52) U.S. Cl. CPC H01M 50/128; H01M 10/48; H01M 50/117

(57) ABSTRACT

A fiber composite component, and to a system including a fiber composite component and an analytical unit.

### FIELD

The invention relates to a fiber composite component, a system comprising a fiber composite component, and an analytical unit, and a battery structure comprising a fiber composite component.

### BACKGROUND

In the course of increasing demand for modern energy storage concepts, especially in the field of electric vehicles, ever larger energy storage units, in particular battery packs and batteries having the highest possible energy density, are being installed. If the chemicals and energy contained in the batteries are released uncontrolled, this can result in catastrophic fires. Among other things, such a process can be triggered by mechanical damage to the batteries. Battery cases made of fiber composite material are increasingly used because they have advantages over metals in the combination of the requirements for fire protection, crash safety, insulation, and lightweight construction. Due to their typical layer-based structure and the process-related simultaneous production of material and the component consisting thereof, fiber composite materials offer much better options for adapting to the specific requirements of the component compared to metals.

Fiber composite components with which the above requirements profile can better be met, in particular by realizing different functionalities, such as a flame-retardant effect, in technical items, are already known from the prior art.

US 2005/0170238 A1 discloses, for example, a battery housing which is formed from a flame-retardant polymer composition made of high-density polyethylene, which can comprise a glass fiber reinforcement and a fire-resistant additive. During production, the fire-resistant additive is mixed in the melt with the polyethylene to be protected and the mass is subsequently pressed into the desired shape.

US 2020/0152926 A1 describes a lid for a battery pack of an electric vehicle with a frame consisting of a layer composite. A first layer of the composite comprises a so-called “shear panel” which has a fiber-reinforced composite layer which is intended to counteract a shear deformation during an impact. As a separate element, the layer composite comprises a fire-and abrasion-resistant second functional layer which is deposited on the shear panel and which faces the battery when the shear panel is connected to the frame of the vehicle.

Although components with the fiber composite components described above can be better protected by external impairments such as flame activity or mechanical loads, this protection is insufficient in many applications, in particular in the field of battery technology, and considerable safety risks can arise, for example due to release of the battery materials, when the component is mechanically impaired.

### SUMMARY

Against this background, the object of the present invention was therefore to provide a fiber composite component with which the above-described disadvantages from the prior art can be avoided, and which enables or simplifies the protection of an item, such as a battery, that is protected with the component in particular during operation. In particular, maintenance stops and possibly necessary disassembly work are to be avoided by means of said component, and the effort and costs of the protection thereby kept as low as possible.

This object is achieved according to the invention by a fiber composite component which is suitable in particular for protecting components against mechanical loads, and which has the following components:
a) a fiber material, preferably in the form of a textile layer,
b) a matrix material,
characterized in that the fiber composite component further comprises
c) a sensor element, wherein the sensor element is preferably an electrically conductive structure which is insulated from the fiber material.

For the sake of linguistic simplicity, reference is made below to “a” fiber material and/or “a” matrix material and/or “an” additive and/or “a” sensor element and/or “a” conductor and/or “an” electrical conductor and/or “an” electrically conductive structure and/or “a” functional region, and/or “a” matrix material and/or “a” concentration gradient. However, this is not to be understood as a numerical limitation. In the following, the use of the singular is always to be interpreted such that it can also be “one or more” of the corresponding component.

A “fiber composite component” is understood to mean a material of two or more connected materials which have different material properties than its individual components and which can serve as a component of a technical item. Such a component can be, for example, a plate or a housing of a machine. However, the term “fiber composite component” also includes fiber composite components which can form a technical item per se. The fiber composite component comprises at least one fiber material and a matrix material. The fiber composite component according to the invention is preferably a glass fiber reinforced plastic (GRP) or a carbon fiber reinforced plastic (CFRP).

A “sensor element” is a sensor device component whose property change(s) (e.g., change in resistance or conductivity) are detected by the further elements of the sensor device, in particular the analytical unit, and converted into an electrical signal. A sensor device is a technical component which can detect certain physical or chemical properties and/or the material properties of its surroundings qualitatively or quantitatively as a measured variable. It consists at least of a sensor element, which according to the invention is arranged in the fiber composite component, and an analytical unit. It can also comprise further elements, such as a signal output and/or a control system.

The sensor device can determine whether there is an impairment of the integrity of the fiber composite component. In a simple case, the sensor element is, for example, an electrical conductor which is part of a closed circuit comprising an electrical conductor and analytical unit. However, the analytical unit can be, but does not have to be, part of the fiber composite component. For example, it can also be connected to the electrical conductor only via contacting elements. When the fiber composite component is mechanically impaired, for example due to impact of stones, the component together with the electrical conductor arranged therein can bend, as a result of which the circuit is interrupted. The integrity of the fiber composite component can thereby be deduced.

All measured variables with which the mechanical state of the fiber composite component can be deduced are suitable for checking the integrity. The measured variable, for example a specific physical or chemical property (physically, for example, amount of heat, temperature, humidity, pressure, sound field variables, brightness, acceleration or chemically, e.g., pH, ionic strength, electrochemical potential) and/or the material properties of the surroundings is detected qualitatively and/or quantitatively by the sensor device. In contrast to the “simple case” described above, the measured variables obtained thereby can also enable a significantly more complex analysis of the state of the fiber composite component. In particular, if different measured variables are determined and used for assessing the state.

A sensor element can be formed, for example, by one or more piezoelectric sensor elements (piezoelectric ceramics and monocrystalline materials), conductors, in particular optical conductors such as optical waveguides or electrical conductors, such as electrically conductive structures (e.g., electrically conductive wire, conductive fiber, or also a conductor track printed with a conductive print medium). The measuring principle of the sensor device is preferably selected from the group consisting of a mechanical, thermoelectric, resistive, piezoelectric, capacitive, inductive, optical, acoustic and magnetic measuring principle. Examples of sensor devices are thermocouples, pressure and light sensors, and resistance or conductivity sensors.

Preferably, the sensor element is arranged partially, preferably completely, within the component boundaries of the fiber composite component. In another preferred embodiment, the sensor element is arranged on the surface of the fiber composite component.

The fiber composite component preferably completely comprises the sensor device.

The sensor device is preferably arranged within the component boundaries of the fiber composite component. In another preferred embodiment, the sensor device is arranged on the surface of the fiber composite component.

The fiber composite component is preferably designed integrally, i.e., in one piece, i.e., monolithically. The fiber composite component is particularly preferably obtained during its production by integral curing.

“Fiber materials” are materials which have linear, thread-like structures or consist thereof, which in turn preferably are parts of a more complex surface structure such as a woven fabric, a nonwoven, a laid scrim, or a knitted fabric.

The matrix material of the fiber composite component according to the invention serves for at least partially, preferably completely embedding the fiber material, and optionally also for at least partially, preferably completely embedding the sensor element and/or an optional additive and/or optionally for at least partially, preferably completely dissolving an optional additive. It holds the fibers of the fiber material in their position and transfers and distributes stresses between them. It is preferably a polymer material, in particular a thermosetting polymer material. It is preferably a polymer material produced from a resin and a curing agent. In the preparation, accelerators, activators and release agents are preferably used which are then preferably part of the matrix material within the meaning of the present invention.

An “electrically conductive structure” can be, for example, an electrically conductive wire, a conductive fiber, for example a carbon fiber, a conductor track printed with a conductive print medium, or an electrically conductive layer, such as an electrically conductive foil, or an electrically conductive fiber structure layer, such as an electrically conductive textile layer, e.g., a carbon fiber layer. The sensor element can also be formed by a plurality of electrically conductive structures which can be individually connected to the analytical unit. In combination with a surface-filling profile of the electrically conductive structures, this makes it possible to accurately determine the damaged location of the component, so that, depending on the component, an assessment is possible about the need for replacement or the continued safe use despite damage. Analogously, such a “surface-filling” detection of the fiber composite component state can also take place with other sensor elements. As a result, reference is made by way of example to the possibilities for electrical insulation of an electrically conductive structure (as a particularly advantageous embodiment). Of course, corresponding embodiments are also possible analogously with other conductors, in particular electrical conductors.

The electrical insulators which can be used for insulating the electrically conductive structure within the scope of the invention preferably have a high specific resistance, for example in the range of 10⁷-10¹⁶ Ω·cm. The matrix material of the composite component according to the invention can, for example, bring about the insulation of the electrically conductive structure as long as it has no conductive additives, such as metal particles or electrically conductive polymers, at least in the region surrounding the conductive structure. Insulation is preferably achieved by partial, preferably complete, sheathing of the electrically conductive structure, for example with a plastic material. The conductive structure can also be applied to an insulating substrate, such as a foil, and covered by a further insulating substrate. The substrate can, for example, also be a textile fabric of the fiber material, which consists of a non-conductive material. If the substrate is conductive, the electrically conductive structure must be electrically insulated relative to the substrate, for example by a sheath. Insulating layers can also be introduced into the substrate, between which the electrically conductive structure is arranged. Insulation can also be implemented by the electrically conductive structure being arranged between fiber layers, which themselves are electrically insulating.

Preferably, the matrix material, with the exception of an optionally incorporated additive and the incorporated fiber material, has a substantially homogeneous chemical composition, i.e., material boundaries, with the exception of the optionally incorporated additive and the incorporated fiber material, are present not at all or only in adjacent regions of the fiber composite component.

The spatial dimensions of the fiber composite component itself are not limited within the scope of the invention. The fiber composite component can preferably be a plate, such as a fire protection panel. The fiber composite component is preferably monolithic or a fiber composite sandwich panel, i.e., a plate-shaped component in sandwich construction. In the case of a sandwich construction, materials having different properties are assembled in layers to form a component or semi-finished product. Generally, a sandwich panel comprises force-absorbing, fixed outer cover layers, which are kept at a distance by a relatively soft, lightweight core material. The core is preferably made of solid material (e.g., polyethylene, balsa wood), foam (e.g., rigid foam, metal foam), insulating material (e.g., hard foam, mineral wool) or honeycomb lattice (e.g., paper, cardboard, metal, plastic). It transmits thrust forces occurring and supports the outer cover layers. In the case of a fiber composite sandwich panel, at least one of the layers, usually one of the cover layers, is formed from a fiber composite. All outer cover layers are preferably made of a fiber composite. Preferably, at least one, preferably all, cover layers have a wavy structure.

The fiber composite component may also comprise pores, i.e., air and/or gas inclusions, which, however, preferably do not make up more than 5 vol. % of the total volume of the fiber composite component.

By integrating an optional additive which causes or influences a material property, a fiber composite component having increased structural integrity and improved mechanical stability is obtained and simultaneously has a further functionality, such as flame-retardant activity, for example. By means of a concentration gradient of the additive, the spatial profile of the material properties can be adapted for the specific application of the fiber composite component without thereby requiring a complex component structure which demands increased manufacturing effort. For example, flame-retardant additives can be aggregated within a subsection of the functional region defined in more detail below, which subsection is particularly susceptible to fire or high thermal loads.

The fiber composite component according to the invention makes it possible—for example by measuring the conductivity (or the resistance) between points, in particular the end points, of an electrically conductive structure—to easily monitor whether the component has been damaged. In the event of sufficiently strong damage, e.g., by a penetrating object or a strong local impact load, the conductive structure is damaged or severed and therefore, when the electrical conductivity is measured using an analytical unit which is connected to contacting points of the conductive structure, the conductivity drops considerably, which allows a conclusion to be drawn about any damage. If another sensor element is used, an alternative measured variable can also be used to determine damage. Examples of this are sensor elements of inductive sensors or also fiber optic sensors, e.g., coils or glass fibers. Another example is an inclination angle measuring device which can detect an impairment of the component structure by a change in the angle of inclination.

The monitoring can take place during, as well as before or after, the use of the component. The fiber composite component thus also enables (non-destructive) damage monitoring during its intended use. The disadvantages of the generally used checking methods (visual inspection, transmission test (for example X-ray), ultrasound testing, eddy current testing, dye penetration method) can thereby be avoided. In particular, continuous operation can thereby be ensured, and the highest possible safety requirements can be met with such a fiber composite component.

Maintenance stops and any required disassembly are no longer necessary, or, due to the measuring technology used, they are associated with less effort and lower costs. The damage monitoring with the aid of a conductor, e.g., in the form of an electrically conductive structure, can be carried out particularly easily and efficiently and is simultaneously highly sensitive. It is therefore particularly suitable for use in fiber composite parts which are to be produced in larger quantities, for example for the automobile industry.

In many of its intended uses, the fiber composite component is exposed to high mechanical loads and therefore preferably has a particularly pronounced mechanical resistance and/or strength.

In a preferred embodiment of the invention, the fiber composite component therefore has a flexural strength determined according to DIN EN ISO 14125:2011-05 of ≥100 MPa, preferably ≥200 MPa, more preferably ≥400 MPa, still more preferably ≥600 MPa, even considerably more preferably ≥750 MPa, and most preferably ≥1,000 MPa, but generally not more than 20,000 MPa.

In a preferred embodiment of the invention, the fiber composite component has a flexural modulus of elasticity determined according to DIN EN ISO 14125:2011-05 of ≥10 GPa, preferably ≥20 GPa, more preferably ≥30 GPa, still more preferably ≥50 GPa, even considerably more preferably ≥70 GPa, and most preferably ≥100 GPa, but generally not more than 1,000 GPa.

In a preferred embodiment of the invention, the fiber material has, at least partially, preferably completely, a surface structure, preferably a textile surface structure, which is partially, substantially (i.e., more than 90 vol. %), or even completely embedded in the matrix material.

Particularly preferably, the surface structure is selected from the group consisting of laid scrim, knitted fabric, woven fabric, braided fabric, nonwoven fabric or mixtures thereof.

According to the invention, nonwoven is understood to mean a structure of fibers of limited length, continuous fibers (filaments) or cut yarns of any type and any origin, which are joined in some way to form a fiber layer and have been connected to one another in some way. Excluded from this is the crossing or intertwining of yarns, as occurs in weaving, knitting, machine-knitting, lace weaving, braiding and production of tufted products. This definition corresponds to the standard DIN EN ISO 9092. According to the invention, the term nonwoven fabric also covers felt materials. However, films and papers do not belong to the nonwoven fabrics.

In the context of the invention, braiding is understood to mean the regular interleaving of a plurality of strands made of flexible material. The difference from weaving is that, during braiding, the threads are not supplied at a right angle to the main direction of production of the product.

According to the invention, woven fabric is understood to mean a textile fabric consisting of two thread systems, warp (warp threads) and weft (weft threads), which, in view of the fabric surface, intersect at an angle of exactly or approximately 90° in the form of a pattern. Each of the two systems can be constructed from a plurality of warp or weft types (e.g., basic, pile and filling warp: base, binding and filling weft). The warp threads run in the longitudinal direction of the woven fabric, parallel to the selvage, and the weft threads in the transverse direction, parallel to the fabric edge. The threads are connected to the woven fabric predominantly by frictional engagement. In order for a woven fabric to be sufficiently non-slip, the warp and weft threads must usually be woven relatively tightly. Therefore, apart from a few exceptions, the woven fabrics also have a closed fabric appearance. This definition corresponds to the standard DIN 61100, Part 1.

According to the invention, the terms woven fabric and nonwoven also include textile materials that have been tufted. Tufting is a method in which yarns are anchored into a woven fabric or a nonwoven with a machine operated by compressed air and/or electricity.

According to the invention, knitted fabrics are understood to mean textile materials which are produced from thread systems by knitting. These include both crocheted and knitted materials.

According to the invention, a laid scrim is understood to mean a fabric consisting of one or more layers of stretched threads running in parallel. The threads are usually fixed at the crossover points. The fixing takes place either by material bonding or mechanically by friction and/or positive locking. The laid scrim is preferably selected from a monoaxial or unidirectional, biaxial or multiaxial scrim.

Preferably, the fiber material has an anisotropic structure, i.e., within the layered composite according to the invention, the fibers, at least partially, preferably completely, have a specific fiber orientation. Anisotropic mechanical behavior of the layer composite can thereby be produced.

The fiber material is preferably selected from the group consisting of glass fibers, carbon fibers, ceramic fibers, basalt fibers, boron fibers, steel fibers, polymer fibers such as synthetic fibers, in particular aramid fibers and nylon fibers, or natural fibers, in particular natural polymer fibers. Glass fibers and carbon fibers are particularly preferred. Natural fibers are understood to mean fibers which originate from natural sources such as plants, animals or minerals and can be used directly without further chemical conversion reactions. Examples according to the invention are flax, jute, sisal or hemp fibers, and also protein fibers or cotton. According to the invention, it is also possible to use regenerated fibers, i.e., fibers which are produced via chemical processes from naturally occurring, renewable raw materials.

In a preferred embodiment of the invention, the matrix material contains or is a polymeric matrix material, which particularly preferably has one or more thermosets and/or one or more thermoplastics. Preferably, the matrix material is a polymeric matrix material selected from the group consisting of polyurethane, polyvinyl chloride, in particular polyvinyl chloride rigid foam, and phenolic and epoxy resins.

In a preferred embodiment of the invention, at least a portion, preferably all of the fiber material is present in the fiber composite part in the form of one, two or more surface structures, preferably in the form of textile layers which are preferably substantially completely, preferably completely, embedded in the matrix material.

The fiber material and the sensor element, such as a conductive structure, are preferably connected to one another at least partially, preferably completely, directly. The connection is preferably form-fitting, friction-fitting, or material-bonded or a combination of the aforementioned. The connection can be releasable, i.e., released without damaging the components, non-releasable, i.e., the components can only be released from one another by damaging them, or partially releasable, i.e., only the auxiliary joining parts are destroyed, but not the components.

A partially releasable connection is particularly preferred, such as adhesive bonding. Particularly preferred types of connection are stitching, adhesive bonding, or printing.

Particularly preferably, the fiber material has, at least partially, preferably completely, one or more surface structures, preferably in the form of one or more textile layers, and the sensor element, such as a conductive structure, is applied to the surface structure(s) by one or more of the above-described connections. Particularly preferably, the sensor element, such as the conductive structure, is adhesively bonded, printed, applied by means of LDS (laser direct structuring) methods or is stitched with a thread on at least one or more of the textile layers. The screen printing method, but also inkjet methods or CVD/PVD methods, can be used as a method for producing a printed conductive structure, for example.

The fiber composite component is preferably plate-shaped, because such a design can be used universally and can be produced particularly easily for protection of sensitive structures, in particular battery structures. The height, i.e., the thickness, of the plate is at least 0.5 mm, preferably at least 1 mm, more preferably at least 2 mm, still more preferably at least 3 mm, even considerably more preferably at least 4 mm, even significantly considerably more preferably at least 5 mm, and most preferably at least 7 mm.

The height of the plate is preferably a maximum of 25 mm, more preferably a maximum of 20 mm, still more preferably a maximum of 15 mm, even considerably more preferably a maximum 12 mm, even significantly considerably more preferably a maximum of 10 mm, and most preferably a maximum of 8 mm.

The height of the plate is preferably in a range of 0.5-25 mm, more preferably 1-20 mm, still more preferably 1-15 mm, even considerably more preferably 1-10 mm, even significantly considerably more preferably 2-8 mm, and most preferably 2-6 mm.

In particular if the plate is designed as a sandwich panel, the height of the plate is preferably in a range of 3-25 mm, more preferably 4-20 mm.

In particular if the plate is monolithic, the height of the plate is preferably in a range of 0.5-10 mm, more preferably 1-4 mm.

The invention also relates to the use of a fiber composite component as defined in the claims and in the preceding and following sections, as a motor vehicle component, preferably as a body component, particularly preferably as an underbody protection (also referred to as an impact protection plate or underride protection) or bumper, or as a battery housing, battery housing part, battery housing protection, in particular in the form of a protective plate, structural component, composite part for an aircraft and spacecraft, rail vehicle component, or as part of the aforementioned. When used as an underride guard or base plate, in particular for battery housings, it is advantageous if the sensor element, preferably the electrical conductor, is oriented in the center of the component or toward the inside. Oriented toward the inside means arranged further away from the underbody from the center out.

Further preferred motor vehicle components are selected from the group consisting of trunk cargo floors, instrument panels, door and roof claddings, underbody protection parts, structural components, wheel housings, engine compartment parts, brake and clutch linings and disks, acoustic insulation, shear panels, and seals.

The use as part of a battery housing (which does not necessarily have to be part of a motor vehicle), in particular for a lithium ion battery, is particularly preferred. The fiber composite component is particularly preferably the bottom or cover plate.

In a further preferred embodiment of the invention, the fiber composite component is a part of an aircraft or spacecraft, such as an airplane. Preferred parts in this context are tail rotor blades, main rotor hub plates, engine components, tanks, body structures, fire protection elements, such as fire protection layers, rotating parts, turbine blades, and wings.

In a further preferred embodiment of the invention, the fiber composite component is a structural component, for example for a wind turbine. In this context, preferred parts are rotor blades for wind turbines, in particular the structure and outer skin parts of the “nacelle”, lines, and tubes, walls and roofs.

In a preferred embodiment of the invention, the sensor element, such as a conductive structure, has one, two or even more contacting elements for connecting an analytical unit, with which a change in properties of the sensor element, e.g., the change in the conductivity of the conductive structure, can be determined. Contacting elements can be, for example, ends of a conductor track or of an electrical wire, or contacting surfaces which are introduced during production of the fiber composite component (e.g., connected to ends of the conductor or pressed on), wherein the contacting surfaces are, for example, masked or protected in a different form, for example by a silicone bag, during production and can be exposed again after the component has been completed. Such contacting surfaces can be selected from conductive material selected from the group consisting of graphite, conductive polymers, or metals, preferably copper contacting surfaces. In the case of electrical conductivity, the analytical unit can, for example, be a resistance measuring device, e.g., a digital measuring device, for measuring the ohmic resistance. Preferably, the analytical unit can be connected to the contacting element(s) via a detachable connection, optionally via an interposed connection cable with plug connection, wherein the contacting elements of the fiber composite component are preferably themselves part of a plug connection, so that a plug connection can be established between fiber composite component and connection cable or analytical unit. In the simplest case, the sensor element, such as an electrically conductive structure, is formed for example by an electrically conductive wire, and the contacting elements for connecting the analytical unit are contacting points, namely the ends of the wire. In the event of damage to the conductive structure, e.g., due to the effect of an object, an impairment of the conductivity is observed. In the simplest case, the analytical unit only registers whether or not current is flowing, i.e., whether or not the conductive structure is interrupted. In a system comprising a fiber composite component and an analytical unit, the analytical unit is therefore preferably designed and configured such that it registers whether or not current is flowing through the sensor element. The invention also relates to the use of a system of the fiber composite component according to the invention and an analytical unit for registering damage to the fiber composite component. To determine the measured variable, e.g., electrical resistance, the analytical unit can have a voltage or light source and a measuring device, for example for determining the resistance. A wireless transmission between the analytical unit and further elements of the sensor device can preferably be provided if a corresponding transmitter-receiver combination is selected (NFC, WIFI, Bluetooth, induction, etc.), the transmitter of which can be integrated with the fiber composite component and which can wirelessly provide the necessary energy for measuring and transmitting measured values.

The contacting point(s) is/are preferably arranged in depressions in the fiber composite component, so that they are present in a protected manner.

In a plate-shaped design of the fiber composite component, the contacting elements are preferably arranged on the lateral outer surfaces or the fiber composite component is at least designed such that an analytical unit can be connected to the contacting elements, and thus the sensor element, such as an electrically conductive structure, can be connected non-destructively, at least partially, preferably completely, via the lateral surfaces. In other words, the fiber composite component is designed such that it allows contacting via the side face, i.e., the thick side. As shown in the embodiment of FIG. 4, this can be accomplished, for example, by the contacting elements being arranged in a coverable depression to which a laterally dischargeable plug connection can be connected, or by a conductive wire, in particular an electrically conductive wire which is part of the electrically conductive structure, being guided out of the side face of such a plate (FIG. 5). Due to a lateral connection possibility, incorrect detections can be avoided and the integration of the fiber composite part into larger structures, such as a vehicle body, can be simplified.

The sensor element is preferably a conductor, in particular an electrical conductor, for example in the form of an electrically conductive structure, which is preferably insulated at least with respect to a part of the fiber material, particularly preferably with respect to all of the fiber material. In the case of an electrical conductor, this is an electrical insulation. The component preferably has fiber material in the form of fiber structure layers, in particular in the form of textile layers, and the conductor is thus introduced between individual fiber layers of the component such that it is insulated in the component relative to adjacent fiber structure layers, in particular in the form of textile layers. Particularly preferably, the conductive structure is insulated relative to the entire remaining component. As a result, reference is made by way of example to the possibilities of electrical insulation of an electrically conductive structure (as a particularly advantageous embodiment) in order to explain the underlying principle. Of course, corresponding embodiments are also possible analogously with other conductors, in particular other electrical conductors or also optical waveguides.

The insulation is preferably produced by the fiber composite component having two or more fiber surface structure layers, for example textile fiber layers, and the electrically conductive structure being introduced between the individual fiber surface structure layers of the component in such a way that it is insulated from the adjacent fiber surface structure layers in the component.

Insulation can be omitted from adjacent layers if the adjacent, preferably textile layers themselves are electrically insulating. Likewise, the substrate on which the conductor is applied can be conductive if the conductor itself is insulated.

The insulating of the conductive structure, e.g., of the electrically conductive wire, can be implemented, for example, by an insulating plastic sheath.

However, the insulation of the conductive structure can also be achieved by using a non-conductor, e.g., glass fibers, as a complete or substantial component of the fiber material of the two or more adjacent fiber surface structure layers (i.e., preferably more than 70 wt. %, more preferably more than 90 wt. %).

As a further alternative, the conductive structure is connected, at least partially, preferably completely, to a non-conductive fiber material and/or is surrounded by such a fiber material. This material is particularly preferably present in the form of a surface structure, such as a glass fiber mat or fabric.

Particularly preferably, the conductive structure is arranged, at least partially, preferably completely, between two non-conductive fiber structure layers, in particular textile layers, wherein the conductive structure is preferably connected to one or both layers, in particular in an integrally bonding or frictional-fit manner, particularly preferably by means of stitching or printing, and/or the conductive structure, e.g., in the form of an electrical wire, is insulated from the textile layers, for example by a plastic sheath with an insulating plastic.

In a preferred embodiment of the invention, the electrical conductor, e.g., in the form of an electrically conductive structure, consists of at least 70 wt. %, preferably at least 80 wt. %, more preferably at least 90 wt. %, or even at least 95 wt. % or 100 wt. % of a material that has an electrical conductivity o under standard conditions of >0.1*10⁶ S/m, preferably ≥1*10⁶ S/m, more preferably ≥2*10⁶ S/m, more preferably ≥5*10⁶ S/m, still more preferably ≥1*10⁷ S/m, even considerably more preferably >2*10⁷ S/m and most preferably ≥3*10⁷ S/m. Particularly preferably, the material of the electrical conductor is a metal, particularly preferably a metal selected from the group consisting of silver, copper, gold, aluminum, magnesium, tungsten, titanium, iron, or a mixture and/or alloy of the aforementioned, in particular copper or steel. In another preferred embodiment, this material is a conductive polymer, a conductive ink, graphene, or graphite.

Because the fiber composite component according to the invention can in particular be used in molded components for the protection of sensitive structural or functional components, such as batteries, it preferably has a particularly pronounced mechanical resistance.

Particularly preferably, at least a portion, preferably the entire fiber material, is present in the fiber composite part in the form of one, two or more than two fiber structure layers, preferably in the form of two textile layers, wherein at least one, preferably all fiber structure layers are selected from carbon fiber layers or glass fiber layers.

In order to detect damage to the component to be protected as accurately as possible, the conductor, e.g., in the form of an electrically conductive structure, preferably has a complex geometric profile. As a result, reference is made by way of example to the possibilities of the spatial design of the electrically conductive structure (as a particularly advantageous embodiment). Of course, corresponding embodiments are also possible analogously with other conductors, in particular electrical conductors or optical waveguides.

The conductive structure preferably has, at least partially, a curved profile that deviates from a straight profile within the fiber composite component, in particular a meandering or Hilbert curve-shaped profile. For complex profiles of the electrically conductive structure, it can be advantageous to use printed conductor tracks that are printed on or obtained by laser direct structuring. Within the meaning of the invention, a conductor track is any electrically conductive connection with a preferably two-dimensional or multi-dimensional profile obtained by metalization, in particular electrolytically induced metal deposition. Consequently, the term is not limited to the meaning for microelectronics, but comprises it. Such structures enable a high structure variability.

The electrically conductive structure is preferably formed by an electrically conductive wire or an electrically conductive conductor track, wherein the maximum extent of the conductive structure is defined by the maximum distance between two points of the conductive structure F_{E} and wherein preferably the length of the electrically conductive wire or of the conductor track is C_{L}≥F_{E}, preferably C_{L}≥2*F_{E}, more preferably C_{L}≥3*F_{E}, even more preferably C_{L}≥5*F_{E}, even considerably more preferably C_{L}≥10*F_{E}, even significantly considerably more preferably C_{L}≥20*F_{E} and most preferably C_{L}≥50*F_{E}.

According to the invention, the distance between individual subsections of the electrically conductive structure in the case of a curve-shaped profile is selected such that a high detection sensitivity is achieved. Preferably, in a curve-shaped profile, the curves always have a maximum distance of 0.0002*B_{E}, preferably 0.0001*B_{E} or 5 mm, preferably 2 mm, wherein BE is the fiber composite component extension, i.e., the maximum distance between two points of the component. As a result, in the usual applications of such fiber composite components, in particular in the automotive sector, damage can be detected with sufficient accuracy, i.e., the distance of the individual curves is selected such that it is less than the smallest damage to be detected or the smallest penetrating object to be detected.

According to the invention, the distance of the individual portions of the conductive structure, e.g., the conductor track portions, from one another is preferably selected such that it is always lower than the smallest damage to be detected or the smallest penetrating object to be detected. The profile of the conductor tracks is to be selected accordingly. The distance is preferably always ≤10 cm, more preferably always ≤5 cm, still more preferably always ≤2 cm, even more preferably always ≤1 cm, and most preferably always ≤0.5 cm, but generally ≥0.05 cm.

In order to prevent only external, lightweight damage to the component which has no or only a slight influence on the structure and stability of the fiber composite part, the conductive structure is preferably arranged almost completely, i.e., ≥90 vol. %, within the fiber composite component and/or is arranged at a distance from one or all outer surfaces within the fiber composite component. As a result, fault messages due to slight surface damage can be avoided. Preferably, all points of the conductive structure are arranged at a distance of ≥0.1*B_{E}, preferably ≥0.2*B_{E} from all points of one, preferably all, outer surface(s), wherein BE is the fiber composite component extension, i.e., the maximum distance between two points of the component. All points of the conductive structure are preferably arranged at least 0.2 mm, preferably at least 0.5 mm, from all outer surfaces. “Outer surface” is understood to mean a surface which does not adjoin a further region of the fiber composite component and thus delimits the fiber composite component toward the outside, i.e., its surface. In the case of a block-shaped or cuboid design, in particular a plate-like design of the fiber composite component, the above spacing is preferably present relative to two or more outer surfaces.

The electrically conductive structure is preferably selected from the group consisting of electrically conductive wires, electrically conductive polymers, in particular in the form of electrically conductive fibers, electrically conductive conductor tracks, in particular printed conductor tracks. By way of example, it may be a conductor track printed with a conductive print medium (e.g., conductive ink). Particularly preferred, especially due to the simple implementation, is the use of a metal wire, preferably an insulated metal wire, wherein the metal wire is particularly preferably a copper wire or a copper alloy wire. The diameter of a preferably insulated wire is preferably in the range between 0.1 mm and 1.0 mm, preferably 0.1 mm to 0.5 mm, most preferably 0.2 to 0.5 mm.

In a preferred embodiment of the invention, the fiber composite part is designed such that it has at least one electrically conductive structure as a sensor element, wherein a maximum change in the conductivity of the conductive structure of ≤20%, preferably ≤15%, more preferably ≤10%, even considerably more preferably ≤5%, and most preferably ≤2% can be achieved by means of a non-destructive mechanical load.

The invention also relates to a system comprising a fiber composite component having a sensor element, such as an electrically conductive structure, and an analytical unit by means of which a change in properties of the sensor element, e.g., a change in the conductivity of a conductive structure, can be determined, wherein preferably fiber composite component and analytical unit are connected to one another via contacting elements. The fiber composite component is preferably designed as defined in the claims. In a plate-shaped embodiment, this connection is preferably made via an outer surface, particularly preferably via the lateral outer surfaces. The system made up of fiber composite component and analytical unit can be spatially separated and can be permanently or detachably connected to one another via a contact device which is connected to contacting elements of the sensor element and the analytical unit.

The connection of sensor element, such as an electrically conductive structure, and analytical unit, can be effected very generally indirectly, for example via a wire as a contact device.

The invention also relates to a battery structure comprising a fiber composite component having a sensor element, such as an electrically conductive structure, and a battery housing and/or a battery, wherein the fiber composite component is preferably arranged or fastened as a separate element on one of the outer sides of the battery housing or the battery. In a preferred embodiment, the fiber composite component can also be part of the battery housing. A battery housing is suitable for accommodating one or more batteries (in this case also accumulators), in particular lithium-ion accumulators, protects them from mechanical loads and, when the battery is impaired, permanently prevents the outflow and reacting of battery materials. The fiber composite component is particularly preferably an impact protection plate. Particularly preferably, in particular in the case of a plate-shaped design, the battery structure is designed such that, when used as intended, the fiber composite component is arranged below or above the battery housing or the battery. The fiber composite part is preferably designed as defined in the claims. The invention also relates to an impact protection plate which is suitable for acting as part of such a battery structure. The invention also relates to the use of such an impact protection plate for protecting a battery housing or a battery. Damage caused by objects that hit or penetrate into the underbody can thereby be detected.

In a preferred embodiment, the volume ratio of matrix material to fiber material in the fiber composite component is 8:1 to 1:10, preferably 5:1 to 1:8, and particularly preferably 2:1 to 1:5.

In a preferred embodiment, the weight ratio of matrix material to fiber material in the fiber composite component is 5:1 to 1:20, preferably 3:1 to 1:10, and particularly preferably 1:1 to 1:8.

In a preferred embodiment, the volume ratio of matrix material to optional additive in the fiber composite component is 100:1 to 1:5, preferably 50:1 to 1:3, and particularly preferably 2:1 to 1:2.

In a preferred embodiment, the weight ratio of matrix material to optional additive in the fiber composite component is 100:1 to 1:10, preferably 50:1 to 1:6 and particularly preferably 4:1 to 1:4.

In a preferred embodiment, the proportion by weight of fiber material in the total mass of the fiber composite component is from 10 to 95 wt. %, preferably 20 to 90 wt. %, more preferably 30 to 85 wt. %, still more preferably 40 to 80 wt. %, and most preferably 50 to 75 wt. %.

In a preferred embodiment, the proportion by weight of optional additive in the total mass of the fiber composite component is 0.05 to 50 wt. %, preferably 0.1 to 25 wt. %, more preferably 0.3 to 15 wt. %, still more preferably 1.0 to 10 wt. %, and most preferably 2.0 to 5 wt. %.

In a preferred embodiment, the volume ratio of matrix material to fiber material in the functional region is 8:1 to 1:15, preferably 2:1 to 1:10 and particularly preferably 1:1 to 1:10.

In a preferred embodiment, the weight ratio of matrix material to fiber material in the functional region is 5:1 to 1:30, preferably 2:1 to 1:20, and particularly preferably 1:1 to 1:15.

In a preferred embodiment, the volume ratio of matrix material to additive in the functional region is 100:1 to 1:20, preferably 50:1 to 1:6 and particularly preferably 2:1 to 1:4.

In a preferred embodiment, the weight ratio of matrix material to additive in the functional region is 100:1 to 1:20, preferably 50:1 to 1:12 and particularly preferably 4:1 to 1:8.

In a preferred embodiment, the proportion by weight of optionally contained fiber material in the total mass of the functional region is 20 to 80 wt. %, preferably 25 to 70 wt. %, more preferably 35 to 65 wt. %, still more preferably 30 to 60 wt. %, and most preferably 30 to 55 wt. %.

In a preferred embodiment, the proportion by weight of optional additive in the total mass of the functional region is 0.1 to 40 wt. %, preferably 0.2 to 30 wt. %, more preferably 0.5 to 20 wt. %, still more preferably 1.0 to 10 wt. %, and most preferably 1.0 to 5 wt. %.

The proportions of resin, fiber and pores are preferably determined as described in ISO 14127, first edition, 2008.

The optional additive is preferably arranged in a functional region. A functional region is a region which has an additive with a concentration gradient. The functional region thereby has a spatially differently pronounced degree of functionality. Preferably, the functional region has matrix material and/or fiber material. In another preferred embodiment, the functional region does not have a fiber material.

The functional region can also comprise pores, i.e., air and/or gas inclusions, which, however, preferably do not constitute more than 5 vol. % of the total volume of the functional region.

The functional region can preferably form the entire composite component, i.e., the composite component has only one region—the functional region—of which the composite component consists. However, the composite component can also have further regions, in particular further functional regions.

The composite component preferably consists exclusively of regions which comprise both a fiber material and a matrix material.

The functional region gives the composite component a functionality desired for an application purpose, e.g., shielding or fire protection, by providing or influencing specific material properties. For this purpose, the functional region comprises an additive and optionally a fiber material and/or optionally a matrix material or consists of the aforementioned components. In this context, the fiber material of the composite component is not an additive within the meaning of the present invention, i.e., the additive is an additive which is different from the fiber material and causes or influences a material property, in particular an optical, thermal, mechanical and/or electromagnetic material property, in the functional region.

The composite component can be produced by joining different workpieces or coating a workpiece. However, the composite component is preferably formed integrally, i.e., in one piece. The composite component is particularly preferably obtained during its production by integral curing. The functional region can be produced by joining different workpieces or coating a workpiece. However, the functional region is preferably designed integrally, i.e., in one piece. Particularly preferably, the functional region is obtained during its production by integral curing.

The volume fraction of the functional region relative to the total volume of the composite component is preferably ≥2 vol. %, more preferably ≥5 vol. %, still more preferably ≥10 vol. %, even considerably more preferably ≥20 vol. %, even significantly considerably more preferably ≥40 vol. %, and most preferably ≥60 vol. %.

As already described, the optional additive is a component which is contained in the composite component in addition to the fiber material and to the matrix material and which causes or influences, in particular strengthens or weakens, a material property of the functional region, in particular an optical, thermal, mechanical and/or electromagnetic property. This means that one or more material properties of the functional region are newly developed, strengthened or reduced, compared to a region without the corresponding additive. The additive and/or the fiber material are at least partially, preferably substantially, embedded in the matrix material. In this context, substantially means that at least 70 vol. % of the fiber material is completely surrounded by matrix material, preferably at least 75 vol. %, more preferably at least 80 vol. %, still more preferably at least 85 vol. %, still more preferably at least 90 vol. %, and most preferably at least 95 vol. %. Very particularly preferably, the additive and/or the fiber material are completely embedded in the matrix material.

A functional region has a concentration gradient of the additive, so that it comprises disjoint volume elements (i.e., volume elements without a volume intersection) with a different concentration of the additive, and as a result the property caused or influenced by the additive is strongly pronounced in the functional region in a locally different manner. The volume of the disjoint volume elements is preferably ≥1%, more preferably ≥2%, still more preferably ≥5%, but preferably also ≤10% of the total volume of the functional region and/or of the composite component. A concentration gradient denotes a preferably continuous local change in the concentration of the additive within the functional region, preferably within the optional matrix material of the functional region. Continuously is understood to mean a continuous profile of the concentration function, i.e., the concentration values of the concentration gradient. The concentration gradient is preferably predefined, i.e., has a profile of the concentration values and/or direction predetermined by a method measure implemented during the production method. In the context of the invention, concentration is understood to mean the mass concentration, i.e., the mass of the additive per volume unit of the composite component (e.g., g/L).

The spatial dimensions of the regions of the composite component and of the composite component itself are not limited within the scope of the invention. The composite component can preferably be a plate, such as a fire protection panel. A region of the composite component can preferably be a layer. For this case, the composite component is particularly preferably a layer composite or has such a composite. A layer is understood to mean a preferably flat-surfaced mass of a material or a material mixture which preferably has a material boundary with the further regions of the composite component.

The term “material properties of the functional region” comprises all material properties of the material or of the material mixture which forms the functional region. The term includes both physical properties, such as thermal conductivity or expansion coefficient, and chemical material properties, such as combustibility or antimicrobial effect.

In a preferred embodiment of the invention, the material property which the additive causes in the functional region or which the additive influences is a physical material property, preferably an optical, thermal, mechanical, acoustic, electrodynamic, thermodynamic and/or electromagnetic property. Particularly preferably, the physical material property is selected from the group consisting of expansion coefficient, heat capacity, heat conduction/thermal conductivity, ductility, elasticity, strength, hardness, wear resistance, toughness, permeability, in particular magnetic permeability, absorption behavior, and emission behavior, reflection and transparency.

In a preferred embodiment of the invention, the material property which the additive causes in the functional region or which the additive influences is a chemical property. The chemical material property is preferably selected from the group consisting of antimicrobial effect, combustibility, corrosion resistance, solubility and acidity constant.

In a preferred embodiment of the invention, the material property which the additive causes in the functional region or which the additive influences is a physiological material property. The physiological material property is preferably selected from the group consisting of odor, taste and toxicity, in particular ecotoxicity.

An integral character of the functional region with a further region is particularly preferred, particularly preferably with all further regions of the composite component, i.e., an integral design of the composite component.

The composite component preferably consists of a functional region according to the invention. In another preferred embodiment of the invention, however, the composite component has further regions, in particular further functional regions. For example, the composite component can have two or more functional regions according to the invention with different additives.

A concentration gradient consists of a plurality of points. The “points” of the concentration gradient represent concentration values of the additive in the disjoint volume elements of the functional region, i.e., a point which is arranged centrally in the volume element is assigned the corresponding concentration value of the volume element. By connecting the points at different concentrations, the spatial profile of the concentration gradient and thus its length LK can then be determined and set, for example, in relation to the component extension.

A volume element associated with a point of the concentration gradient is preferably obtained and defined in such a way that a portion of the volume of the composite component (e.g., functional region), preferably the entire volume of the composite component, is divided into volume elements of equal volume (i.e., volume deviations ≤5%, preferably ≤2%), and the concentration of the additive in the individual volume elements is determined. Corresponding methods for analyzing the additive content of different additives are known to a person skilled in the art and described in detail in conventional manuals such as, for example, in the Taschenbuch der Kunststoff-Additive [Handbook of Plastic Additives], 3rd edition, Gächter, Müller, Carl Hanser Verlag, 1989, chapter 20. An analysis can take place, for example, by incinerating and/or dissolving components, as explained in ISO 14127, first edition, 2008. The concentration value associated with the point of the concentration gradient can thereby be determined. By comparing the concentration values of the additive for the different disjoint volume elements, such as, for example, layers or cubes, it can then be determined whether a concentration difference is present, i.e., a concentration gradient having two or more points is present. The points with which corresponding concentration values are associated and which thus represent the concentrations in the volume elements are each arranged in the volume centroid of the volume elements. The concentration gradient of the length LK is obtained by connecting the points of different concentration. The points are preferably connected always from one point to the spatially closest, i.e., over the shortest route. The volume of one of the disjoint volume elements is preferably ≥ 1/50 of the total volume of the composite component V_{KB}, still more preferably ≥ 1/20*V^{KB}, still more preferably ≥ 1/10*V^{KB}, but preferably also ≤⅕*V^{KB}. In order to enable a simple and practicable analysis, the composite component can preferably be divided into not more than 200, preferably not more than 100, more preferably not more than 50, even considerably more preferably not more than 10 volume elements of the same volume, and the concentration can be determined from these. The concentration gradient is preferably designed such that the concentration difference of two points which are arranged in succession along the length of the concentration gradient and represent different volume elements is ≥5%, more preferably ≥10%, still more preferably ≥15%, even considerably more preferably ≥20%, based on the higher concentration value in each case. This preferably applies to all adjacent concentration points of a concentration gradient. The concentration gradient preferably has only points with a concentration of the additive >0 and/or the functional region comprises only volume elements which have additive.

Preferably, the concentration value of the volume element having the highest concentration divided by the concentration value of the volume element having the smallest concentration is ≥2, preferably ≥5, still more preferably ≥10, even considerably more preferably >20 and most preferably ≥30 and/or the point spacing thereof is ≥0.01 *B_{E}, preferably ≥0.05 * B_{E}.

In a further preferred embodiment, a volume element, which is represented by one point, is obtained and defined by a layer of a thickness D, which is in each case removed from the composite component by milling, for example, and the concentration thereof is subsequently determined. The volumes of the removed layers are substantially the same (i.e., volume deviations ≤5%, preferably ≤2%). By comparing the concentrations of the additive for the different removed layers, i.e., the disjoint volume elements, it can then be determined whether a concentration difference is present, i.e., a concentration gradient is present. The thickness D of a measured layer is preferably ≤⅓ of the concentration gradient length, more preferably ≤⅕, still more preferably ≤ 1/10, and most preferably ≤ 1/20, but D≥ 1/100 of the concentration gradient length is also preferred. The volume of a layer is preferably ≥ 1/50 of the total volume of the composite component V_{KB}, still more preferably ≥ 1/20*V_{KB}, still more preferably ≥ 1/10*V_{KB}, but preferably also ≤⅕*V_{KB}. The layer density is preferably ≥0.5 mm, more preferably ≥0.1 mm, still more preferably ≥3 mm, still more preferably ≥5 mm, but preferably also ≤5 cm. Preferably, the layer density D≥0.0001*B_{E}, preferably D>0.0004*B_{E}, more preferably D≥0.0006*B_{E}, more preferably D≥0.0008*B_{E}, still more preferably D≥0.001*BE, even considerably more preferably D≥0.005*B_{E}, and most preferably D≥0.01*B_{E}: however, D≤0.01*B_{E} is also preferred.

The concentration gradient is preferably designed such that the concentration difference of two points which are arranged in succession along the length of the concentration gradient and represent different volume elements is ≥ 5%, more preferably ≥10%, still more preferably ≥15%, even considerably more preferably >20%, based on the higher concentration value in each case. This preferably applies to all adjacent concentration points of a concentration gradient.

A concentration gradient may, for example, be formed from 10 concentration values, which represent the concentration of 10 removed layers having a thickness of the corresponding layer of 1 mm, wherein the corresponding points, which represent a concentration in the corresponding layer, always have a concentration difference of at least 20%. The above-described layer-by-layer removal for determining the concentration gradient is particularly suitable in the case of plate-shaped composite components, such as fire protection panels.

Particularly in the case of complex structures or if the functional region is small in relation to the composite component, the gradient can also be obtained and defined by cube-shaped elements being cut out of the composite component, the edge length of which is preferably ≤⅓ of the concentration gradient length, more preferably ≤⅕, still more preferably ≤ 1/10 and most preferably ≤ 1/20, but the edge length is preferably also ≥ 1/100 of the concentration gradient length. The volumes of the cubes are substantially the same (i.e., volume deviations≤5%, preferably ≤2%). The volume of a cube is preferably ≥ 1/50 of the total volume of the composite component V_{KB}, still more preferably ≥ 1/20*V_{KB}, still more preferably ≥ 1/10*V_{KB}but preferably also ≤⅕*V_{KB}. The edge length of the corresponding cube is preferably ≥0.5 mm, more preferably ≥1 mm, more preferably ≥3 mm, even more preferably ≥5 mm, but preferably also ≤5 cm. Preferably, the edge length of the cube is ≥0.0001*B_{E}, preferably ≥0.0004*B_{E}, more preferably ≥0.0006*B_{E}, more preferably ≥0.0008*B_{E}, still more preferably ≥0.001*B_{E}, even considerably more preferably ≥0.005*B_{E}, and most preferably ≥0.01*B_{E}; however, the edge length is preferably also ≤0.01*B_{E}. A concentration gradient can be formed, for example, from 10 concentration values which represent the concentration of 10 cut out cubes having an edge length of 1 mm, wherein the corresponding points arranged in the middle of the cube which represent a concentration in the corresponding cube, always have a concentration difference of at least 20%.

The concentration gradient is preferably designed such that the concentration difference of two points which are arranged in succession along the length of the concentration gradient and represent different volume elements is ≥5%, more preferably ≥10%, still more preferably ≥15%, even considerably more preferably >20%, based on the higher concentration value in each case. This preferably applies to all adjacent concentration points of a concentration gradient.

In a preferred embodiment of the invention, the concentration values of the concentration gradient increase or fall along its spatial profile, i.e., its length Lk, at least partially, preferably completely, continuously. In a preferred embodiment of the invention, the concentration gradient has a continuous profile of the concentration values over more than 10%, preferably more than 20%, still more preferably more than 40%, even more preferably more than 60%, and most preferably more than 75% of its length LK. Due to a continuous profile of the concentration values of the concentration gradient, segregation effects and predetermined breaking points within the functional region are avoided, and the strength and resistance of the material are thereby increased.

In a preferred embodiment, the concentration gradient has a monotonically increasing profile of the concentration values over its length LK at least partially, preferably completely, i.e., each measurement point has a higher concentration than the preceding one. In another preferred embodiment, the concentration gradient has a monotonically decreasing profile over its length LK at least partially, preferably completely, i.e., each measurement point has a lower concentration than the preceding one.

The concentration gradient has over its length LK a profile of the concentration values which, at least partially, preferably completely, is selected from the group consisting of linearly increasing, stepwise increasing, stepwise decreasing, non-linearly increasing, linearly decreasing, exponentially decreasing, exponentially increasing, and non-linearly decreasing.

In a preferred embodiment of the invention, the composite component has a maximum component extension BE, which is defined by the maximum distance between two points of the component, and the concentration gradient has a length LK, where L_{K}≥0.05*B_{E}, preferably L_{K}≥0.2*B_{E}, more preferably L_{K}≥0.3*B_{E}, still more preferably L_{K}>0.4*B_{E}, still more preferably L_{K}≥0.6*B_{E} and most preferably L_{K}≥0.75*B_{E}.

In a preferred embodiment of the invention, the functional region has a maximum functional region extension FB_{E}, which is defined by the maximum distance between two points of the functional region, and the concentration gradient has a length L_{K}, where L_{K}≥0.05*FB_{E}, preferably L_{K}≥0.2*FB_{E}, more preferably L_{K}>0.3*FB_{E}, more preferably L_{K}>0.4*FB_{E}, still more preferably L_{K}≥0.6*FB_{E} and most preferably L_{K}≥0.75*FB_{E}.

As a result of the most extensive possible extension of the preferably continuous concentration gradients, the most uniform possible transition between the zones of different concentrations of the additive is achieved. The composite component therefore has an increased structural integrity and strength.

The composite component is preferably a plate, such as a fire protection panel. For this case, the concentration gradient preferably runs along the height H_{B} of the plate. Preferably, the concentration gradient, in particular for this case, has a length LK where L_{K}>0.05*H_{B}, preferably L_{K}>0.2*H_{B}, more preferably L_{K}≥0.3*H_{B}, more preferably L_{K}>0.4*H_{B}, still more preferably L_{K}>0.6*H_{B}and most preferably L_{K}≥0.75*H_{B}. In other preferred embodiments, the concentration gradient runs along the length L_{B} of the plate. Preferably, the concentration gradient, in particular for this case, has a length L_{K} where L_{K}>0.001*L_{B}, preferably L_{K}≥0.004*L_{B}, more preferably L_{K}≥0.006*L_{B}, more preferably L_{K}≥0.008*L_{B}, still more preferably L_{K}≥0.012*L_{B} and most preferably L_{K}≥0.015*L_{B}. In other exemplary embodiments, the concentration gradient runs along the width BB of the plate. Preferably, the concentration gradient, in particular for this case, has a length L_{K}, where L_{K}≥0.001*B_{B}, preferably L_{K}>0.004*B_{B}, more preferably L_{K}≥0.006*B_{B}, more preferably L_{K}≥0.008*B_{B}, still more preferably L_{K}≥0.01*B_{B} and most preferably L_{K}≥0.012*B_{B}. In the above embodiments, the concentration gradient preferably has only points with a concentration of the additive >0, i.e., the profile of the concentration values is completely different from zero along the spatial profile of the gradient, and/or the functional region and optionally the composite component are designed in one piece, preferably cured in one piece. Also possible and preferred are combinations of the above preferred embodiments in which the concentration gradient has in each case a component along 2 or 3 of the plate axes (length, width, height).

The concentration gradient preferably has at least three points with different concentration values, preferably at least five points, still more preferably at least ten points, still more preferably at least 20 points, and most preferably at least 50 points, wherein these points are preferably uniformly spaced apart. The concentration gradient is then preferably designed such that the concentration difference of two points, which are arranged in succession along the length of the concentration gradient and represent different volume elements, is ≥ 5%, more preferably ≥ 10%, still more preferably >15%, even considerably more preferably ≥ 20%, based on the higher concentration value in each case. This preferably applies to all adjacent concentration points of a concentration gradient. Particularly preferably, in this case, the concentration gradient has one of the lengths LK defined above in relation to the component extension B_{E} and/or to the functional region extension FB_{E} and/or one of the aforementioned profiles. Preferably, none of the concentration points forming the gradients is arranged within the optional fiber material.

Preferably, the concentration gradient is arranged completely within the functional region and particularly preferably corresponds to the concentration gradient of the functional region extension FB_{E}.

In a preferred embodiment of the invention, the profile of the concentration values of the concentration gradient has at least two differently designed partial regions. For example, the profile of the concentration values of the concentration gradient can first decrease linearly and then increase stepwise. Complex concentration profiles can thereby be realized in the composite component. Preferably, the concentration gradient has partial regions of different inclination.

In a preferred embodiment of the invention, the concentration gradient has a point of highest concentration Cₘₐₓ and a point of lowest concentration Cₘᵢₙ where Cₘₐₓ/Cₘᵢₙ≥2, preferably ≥5, still more preferably ≥10, even considerably more preferably ≥20 and most preferably ≥30. A high local difference in the development of the material property caused or influenced by the additive in the functional layer can be achieved by a correspondingly steep gradient of the concentration values.

Particularly preferred is an embodiment in which the point of highest concentration Cₘₐₓ and the point of lowest concentration Cₘᵢₙ of the concentration gradient have a minimum distance L_{Cmax->min} where L_{Cmax->min}≥0.05*B_{E}, preferably L_{Cmax->min}≥ 0.2*B_{E}, more preferably L_{Cmax->min}≥0.3*B_{E}, more preferably L_{Cmax->min}≥0.4*B_{E}, still more preferably L_{Cmax->min}≥0.5*B_{E}.

For other applications, however, it can also be advantageous that, although a gradient exists in the functional region, the local concentration differences are limited. In another preferred embodiment of the invention, Cₘₐₓ/Cₘᵢₙ is therefore ≤2, preferably ≤5, still more preferably ≤10, even considerably more preferably ≤20 and most preferably ≤30.

In a preferred embodiment of the invention, Cₘₐₓ/Cₘᵢₙ is in a range between 1.5-50, preferably 3-30, still more preferably 5-25, even considerably more preferably 5-20, and most preferably 7-15.

In the preferred embodiments described above, the composite component particularly preferably has a maximum component extension B_{E} which is defined by the maximum distance between two points of the component, and the concentration gradient preferably has a length L_{K} where L_{K}≥0.05*B_{E}, preferably L_{K}≥0.2*B_{E}, more preferably L_{K}≥0.3*B_{E}, more preferably L_{K}≥0.4*B_{E}, still more preferably L_{K}≥0.6*B_{E}and most preferably is L_{K}≥0.75*B_{E}.

Preferably, the concentration gradient is designed such that an increased additive concentration is present on one of the plurality of or all of the surfaces of the composite component and decreases toward the interior or vice versa.

In a preferred embodiment of the invention the concentration gradient therefore runs at least partially parallel to or in extension to an orthogonal projection of one of the outer surfaces of the functional region: particularly preferably in this case, the concentration of the additive increases at least partially, preferably continuously, toward one of the outer surfaces. Within the meaning according to the invention, an orthogonal projection is an image of a point on a plane which forms one of the outer surfaces of the composite component, so that the connecting line between the point and its image forms a right angle with this plane. The image then has the shortest distance to the starting point of all points of the plane.

The concentration gradient is preferably designed such that the point of the highest concentration of the gradient Cₘₐₓ is arranged on or in the immediate vicinity, i.e., in a spacing of no more than 0.1*B_{E}FROM all points of the closest outer surface. “Outer surface” is understood to mean a surface which does not adjoin a further region of the composite component and thus delimits the composite component toward the outside. In a preferred embodiment of the invention, the functional region has two or more concentration gradients, wherein the two or more concentration gradients are preferably designed such that the concentration of the additive increases toward the same outer surface.

Because the additive often serves to control a material property which is in a particular functional relationship with the outer surfaces, such an arrangement is particularly preferred. For example, the additive can serve to improve the impact resistance and, therefore, is particularly preferably accumulated at or near one of the outer surfaces. This embodiment is particularly preferable in particular also when the additive is to be subjected to further thermal treatment, such as carbonization, after introduction into the composite component.

In another preferred embodiment, the concentration gradient is designed such that the point of the highest concentration is arranged centrally in the component, i.e., at a distance >0.1*B_{E}, preferably >0.2*B_{E} FROM the closest or all outer surfaces. In the case of a block-shaped or cuboid design of the component, the above spacing is preferably present relative to two or more outer surfaces.

In a preferred embodiment of the invention, the functional region is a fire protection region and has, for this purpose, a flame retardant as an additive which reduces the combustibility of the functional layer.

In general and in this case, the flame retardant is particularly preferably selected from the group consisting of halogenated and/or nitrogen-based flame retardants, inorganic flame retardants, such as graphite salts, aluminum trihydroxide, antimony trioxide, ammonium polyphosphate, aluminum diethylphosphinate, mica, muscovite, guanidines, triazines, sulfates, borates, cyanurates, salts thereof, and mixtures thereof.

Like the optional other regions, the functional region can have further additives. In particular, the functional region can have a plurality of different additives which have different, preferably continuous, concentration gradients.

In other preferred embodiments, the optional additive is very generally selected from the group consisting of antioxidants, light stabilizers, in particular UV stabilizers, plasticizers, foaming agents, electrical conductors, heat conductors, dyes, fillers for improving the mechanical properties, such as impact modification, or rubber or thermoplastic particles, and mixtures of the aforementioned.

The additive can be present in dissolved or dispersed form in the matrix material. If it is dispersed, it is preferably contained in the form of a powder, flakes, tubes or mixtures of the aforementioned forms.

If the additive is a flame retardant, it is preferably selected from the group of active, i.e., cooling, flame retardants or from the group of passive, i.e., insulating, flame retardants. Particularly preferably, the flame retardant is an intumescent flame retardant.

In a preferred embodiment of the invention, all of the additive located in the fiber composite component is present in the functional region, substantially, i.e., ≥70 wt. %, preferably ≥80 wt. %, even more preferably ≥90 wt. %, and most preferably completely, in a spatially delimited first subsection of the functional region. This first subsection preferably encloses at least one outer surface of the fiber composite component at least partially, preferably completely. If the fiber composite component has more than one functional region, the aforementioned weight proportion and the volume portions mentioned below preferably relate to one or more than one functional region.

In a preferred embodiment of the invention, the volume V_{T1} of the first subsection, in which the additive of the functional region is substantially located, makes up a considerable part of the total volume of the functional region V_{FB}. Preference is given to V_{T1}≥0.1*V_{FB}, more preferably V_{T1}≥0.3*V_{FB}, still more preferably V_{T1}≥0.5*V_{FB}, still more preferably V_{T1}≥0.7*V_{FB} and most preferably V_{T1}≥0.9*V_{FB}.

In a preferred embodiment of the invention, which is preferably combined with the above preferred embodiment, the functional region has a second subsection in which there is no additive. The volume V_{T2} of this second subsection is preferably V^{T2}≤0.7*V_{FB}, more preferably V^{T2}≤0.5*V_{FB}, more preferably V^{T2}≤0.3*V_{FB}, still more preferably V^{T2}≤0.2*V_{FB}and most preferably V^{T2}≤0.1*V_{FB}.

In another particularly preferred embodiment, all of the additive located in the fiber composite component is arranged substantially, preferably completely, in the functional region.

In a preferred embodiment of the invention, the volume V_{T1} of the subsection in which the additive of the functional region is substantially located is low in relation to the total volume of the fiber composite component V_{FB}. Preference is given to V_{T1}≤0.7*V_{FB}, more preferably V_{T1}≤ 0.5*V_{FB}, more preferably V_{T1}≤0.3*V_{FB}, still more preferably V_{T1}≤0.2*V_{FB} and most preferably V_{T1}≤0.1*V_{FB}.

In a preferred embodiment of the invention, which is preferably combined with the above preferred embodiment, the functional region has a second subsection in which there is no additive. The volume V_{T2} of this second subsection is preferably V_{T2}≥0.1*V_{FB}, more preferably V_{T2}≥0.2*V_{FB}, more preferably V_{T2}≥0.3*V_{FB}, still more preferably V^{T2}>0.5*V_{FB}and most preferably V_{T2}≥0.7*V_{FB}.

Preferably, the volume of the functional region forms more than 50% of the volume of the fiber composite component, more preferably more than 65%, still more preferably more than 75%, even considerably more preferably more than 90% and most preferably more than 95% or even 100%. For these cases, the fiber composite component is particularly preferably designed in one piece, preferably cured in one piece.

In a preferred embodiment of the invention, the volume V_{T1} of the first subsection, in which the additive of the functional region is substantially located, makes up a considerable part of the total volume of the fiber composite component V_{KB}. Preference is given to V_{T1}≥0.1*V_{KB}, more preferably V_{T1}≥0.3*V_{KB}, still more preferably V_{T1}≥0.5*V_{KB}, still more preferably V_{T1}≥0.7*V_{KB}and most preferably V_{T1}≥0.9*V_{KB}.

In a preferred embodiment of the invention, which is preferably combined with the above preferred embodiment, the functional region has a second subsection in which there is no additive. The volume V_{T2} of this second subsection is preferably V_{T2}≤0.7*V_{KB}, more preferably V_{T2}≤0.5*V_{KB}, more preferably V^{T2}≤0.3*V_{KB}, still more preferably V^{T2}≤0.2*V_{KB}and most preferably V_{T2}≤0.1*V_{KB}.

In a preferred embodiment of the invention, the volume V_{T1} of the subsection in which the additive of the functional region is substantially located is low in relation to the total volume of the fiber composite component V_{KB}. Preference is given to V_{T1}≤0.7*V_{KB}, more preferably V_{T1}≤0.5*V_{KB}, more preferably V_{T1}≤0.3*V_{KB}, still more preferably V_{T1}≤0.2*V_{KB}and most preferably V_{T1}≤0.1*V_{KB}.

In a preferred embodiment of the invention, which is preferably combined with the above preferred embodiment, the functional region has a second subsection in which there is no additive. The volume V_{T2} of this second subsection is preferably V_{T2}≥0.1*V_{KB}, more preferably V^{T2}>0.2*V_{KB}, more preferably V_{T2}≥0.3*V_{KB}, still more preferably V_{T2}≥0.5*V_{KB}and most preferably V_{T2}≥0.7*V_{KB}.

Preferably, the volume of the functional region forms more than 50% of the volume of the fiber composite component, more preferably more than 65%, still more preferably more than 75%, even considerably more preferably more than 90%, and most preferably more than 95%. For this case, the fiber composite component is particularly preferably designed in one piece, preferably cured in one piece.

In a particularly preferred embodiment, the functional region has only volume portions with additive, i.e., V_{T1}=V_{FB}, and/or the fiber composite component consists of the functional region, i.e., V_{FB}=V_{KB}.

Particularly preferably, the additive is present at ≥70 wt. %, preferably ≥80 wt. %, still more preferably ≥90 wt. %, still more preferably ≥95 wt. % and most preferably completely in the volume V_{FB}.

The invention also relates to a method for producing one of the aforementioned fiber composite components, comprising the following steps:
I) providing a composition for forming a fiber composite component in a shaping tool, such as a press mold, comprising or consisting of
a) a fiber material, preferably in the form of one or more fiber structure layers, in particular in the form of textile layers,
b) a matrix material, and
c) a sensor element, such as an electrically conductive structure,
d) an optional additive
II) exerting a predetermined pressure, preferably by pressing, and a predetermined temperature on the composition in order to obtain the fiber composite component.

The sensor element is preferably present in the form of an electrically conductive structure, such as a conductor track or an electrically conductive wire, applied to a substrate (e.g., fiber structure layer), wherein particularly preferably this conductor track or this wire is completely covered by the substrate, i.e., on all sides. In another preferred embodiment, the conductive structure can also be present as a wire provided partially or completely with an electrically insulating sheath, which wire can preferably be connected to a substrate. Preferably, at least a portion of the conductive structure is arranged during the production process in a protective shell, such as a silicone bag, which can be removed again after the production process.

Preferably, the conductive structure has contacting points which are protected before step II), for example by a dummy contact, and are again exposed after II).

Step I) preferably comprises one, more or all of the following sub-steps:
a) connecting one or more layers of a fiber material to the conductive structure, for example by stitching or printing,
b) providing, in particular stacking, one or more layers of a fiber material in a shaping tool, for example using a robot arm,
c) providing one or more precursor compounds for a matrix material,
d) providing one or more additives, preferably dissolved in the one or more precursor compounds,
e) bringing the one or more precursor compounds for a matrix material in contact with the fiber material, preferably by applying
f) at least partial reaction of the one or more precursor compounds, such as a system of resin, hardener, and an optional release agent in order to obtain a matrix material (=curing)

In the method according to the invention, the sensor element can very generally be introduced into the fiber composite component, in particular into the functional region, for example by the following method measures:
i) a sensor element, such as an electrically conductive wire, is stitched on, printed or adhesively bonded onto one or more layers of the fiber material,
ii) a conductive polymer is applied to one or more layers of the fiber material or to the cured matrix,
iii) an electrical conductive structure is deposited by deposition processes, in particular CVD or PVD, onto one of the layers of the fiber material or onto the cured matrix iii) a conductor track is defined by a laser beam (laser direct structuring).

In the method according to the invention, the optional additive can very generally be introduced into the fiber composite component, in particular the functional region, by the following method measures:
i) the fibrous material used can be provided with the additive, for example by applying a solution of the additive or applying an additive powder which can optionally be provided with a binder for better adhesion to the fiber material,
ii) the additive is preferably introduced into the one or more precursor compounds in dissolved and/or dispersed form,
iii) the additive is introduced into a shaping tool that is unfilled, or is filled partially or completely with the one or more precursor compounds.

The local modification of the material properties by varying additive distribution of the optional additive in the matrix material can be produced by way of example by
i) different local accumulation of the additive on the fibrous material or on a prepreg which is introduced into the shaping tool,
ii) varying the concentration of the additive present in dissolved and/or dispersed form in the one or more precursor compounds during introduction into the shaping tool,
iii) the additive is introduced locally gradually into the at least partially filled shaping tool before, during or after the reaction of the one or more precursor compounds.

The predetermined pressure in step II) of the above-defined method is preferably in a range from 1 bar to 1000 bar, particularly preferably from 5 bar to 500 bar, still more preferably from 10 bar to 100 bar, and most preferably from 20 to 50 bar.

The predetermined temperature in step II) of the above-defined method is preferably in a range from 10° C. to 900° C., particularly preferably from 15° C. to 700° C., still more preferably from 20° C. to 500° C., and most preferably from 25° C. to 200° C.

Particularly preferably, the method for producing the fiber composite component according to the invention is a wet pressing method. In such a method, liquid reaction resins are processed as precursor compounds together with reinforcing fibers in two-part molds. The upper mold part and lower mold part are closed by means of a press.

In the wet pressing process, the resin is usually poured onto the fiber mats centrally or following a fixed pouring schedule. In this step, the additive can be added at different points in time with a preferably varying concentration.

In most cases, polyurethane, epoxy resin or polyamide systems are used which are formed from two or more precursor compounds that are mixed in a special mixing head to form a reactive liquid plastics material. A flat sheet die or other distributor systems are preferably used for flat application on the fiber mats.

The fiber mats are preferably laid as fiber carpets. Such a method is characterized by a particularly high efficiency.

The plastic is distributed within the entire mold by the closing process of the tool under the pressure of the press and wets the reinforcing fibers. At the same time or thereafter, the plastic/resin is cured—usually at elevated temperature. If the plastic is cured, this provides the dimensional stability of the component, which can be demolded after the tool has been opened.

The optional additive is preferably introduced into the functional layer by admixture into one or more of the precursor compounds for the matrix material. By varying the additive proportion, a concentration gradient can thereby be generated when the matrix material is fed into the shaping tool.

In the methods for producing the fiber composite components according to the invention, the fiber mats can be pre-formed to form a so-called preform, in particular when there is increased geometric complexity.

An insulated copper wire as the conductor (diameter 0.4 mm) is stitched onto a substrate made of a glass fiber mat (arbitrary basis weight) in a meandering manner. 6 mm is selected as the stitch spacing for the stitching. For the detection of damage with a diameter x, the spacing between the conductors must be x−1 mm, so that damage can be reliably detected. The spacing between the copper wire and the edge of the glass fiber mat is 50 mm all around, so that the finished component can be trimmed to the final dimension without damaging the wire. Contacting elements, namely copper plates having a diameter of 20 mm and a thickness of 3 mm, are soldered to the ends of the conductor track. The contacts are insulated from both sides by means of polyester fleece layers. A stack of 4 carbon fiber laid scrims and substrate with the conductor (glass fiber mat with copper wire) and a further layer of glass fiber mat (sequence: carbon fiber laid scrim/carbon fiber laid scrim/glass fiber mat/glass fiber mat with copper wire/carbon fiber laid scrim/carbon fiber laid scrim) is placed one above the other, and in the wet press method using an epoxy resin as matrix material is pressed to form a fiber composite component. After curing of the component, the contacting surfaces are exposed again by means of a machining method (drilling, milling). The contact points thus exposed can then be electrically contacted by means of spring pins.

### BRIEF DESCRIPTION OF THE FIGURES

The present invention is explained in more detail below with reference to the exemplary embodiments indicated in the figures.

FIG. 1 shows a layer stack for a fiber composite component with an electrical conductor.

FIG. 2 schematically shows a fiber composite component in which an insulated electrically conductive wire is arranged and the contacting can take place via contacting elements in drilled depressions.

FIG. 3 schematically shows a fiber composite component in which an insulated electrically conductive wire is arranged and the contacting can take place via lateral contacting elements.

FIG. 4 schematically shows a fiber composite component in which an insulated electrically conductive wire is arranged and the contacting can take place via contacting elements in milled depressions/notches.

FIG. 5 schematically shows a fiber composite component in which an insulated electrically conductive wire is arranged and the contacting elements are located outside the component

### DETAILED DESCRIPTION

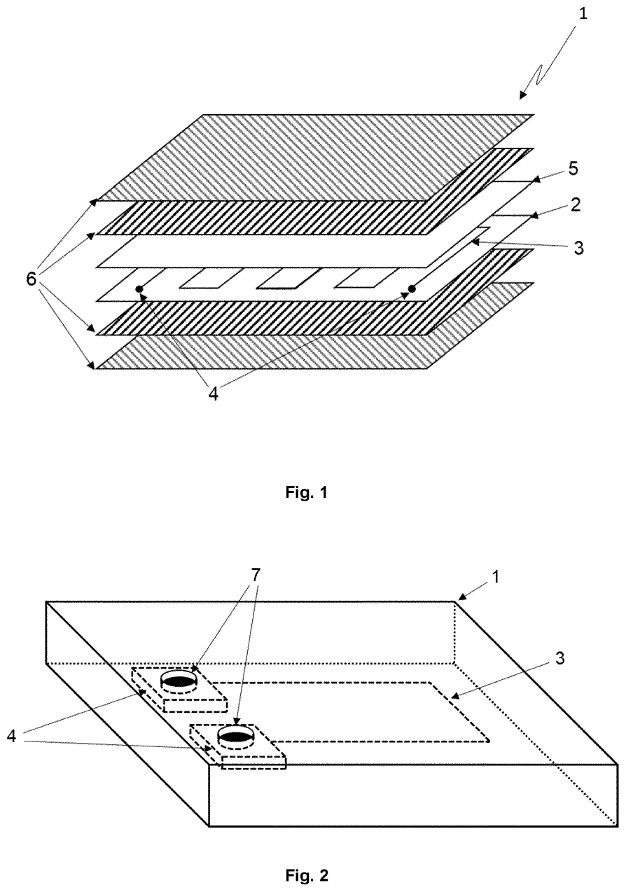

FIG. 1 schematically shows a structure of a fiber composite component (1). An electrical conductor (3) having a meandering profile and two contacting points (4) at the ends of the conductor is applied to the insulating substrate (2), and a further layer of insulating material (5) is arranged over said conductor. The system of substrate, electrical conductor, and material insulating layer is embedded in a sequence of textile layers (6), which in turn are surrounded by a matrix material (not shown).

FIG. 2 schematically shows how the contacting elements (4) of the conductor (3), which are completely embedded in a fiber composite component (1), can be exposed in drilled recesses (7) in one of the component outer sides and thus contacted in order to connect the sensor element (3) formed by the conductor to an analytical unit (not shown). The depression can be closed with a cover element (not shown) in order to protect the contacting elements.

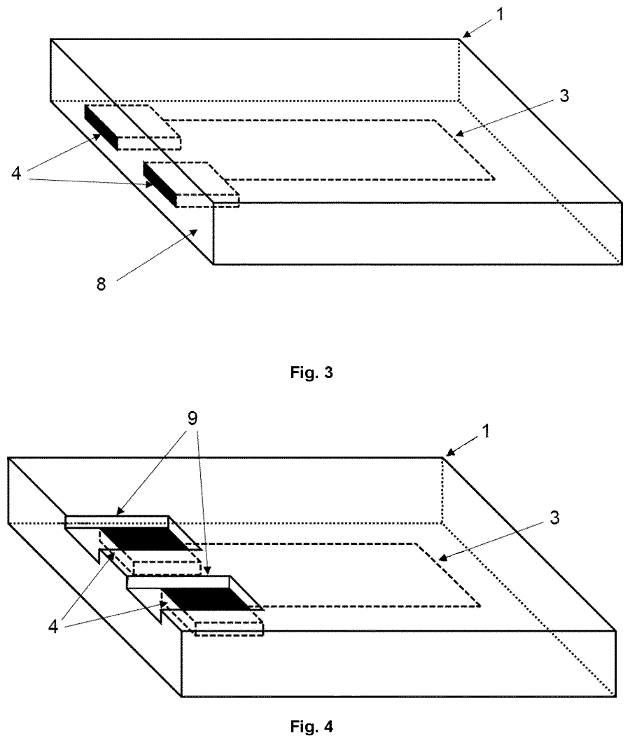

FIG. 3 schematically shows how the contacting elements (4) of the conductor (3), which is embedded in a fiber composite component (1), can be placed such that they can be trimmed from a side face (8) of the component and thus can be contacted directly without any additional drilling in order to connect the sensor element formed by the conductor to the analytical unit (not shown). It is thus avoided that installation space above the fiber composite component is required for contacting with the analytical unit (not shown).

FIG. 4 schematically shows how the contacting points (4) of the conductor (3), which are completely embedded within the fiber composite component (1), are exposed by milled depressions/notches (9) and can thus be contacted coming from the side face (8) in order to connect the sensor element formed by the conductor to the analytical unit (not shown). It is thus avoided that installation space above the fiber composite component is required for contacting with the analytical unit.

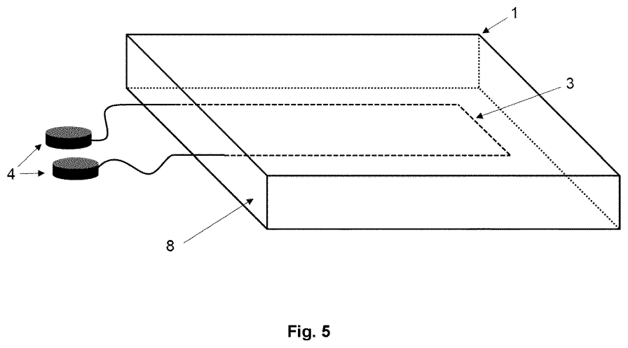

FIG. 5 schematically shows how at least one of the ends of the conductor (3) can be guided to the outside directly through a side face (8) of the fiber composite component (1), so that the contacting elements (4) are located outside the component and can be contacted there in order to connect the sensor element formed by the conductor to the analytical unit (not shown).

### REFERENCE SIGNS

1 fiber composite component
2 substrate
3 electrical conductor
4 contacting elements
5 insulating layer
6 textile layers
7 bores for contacting element
8 side face
9 recesses/notches

1-17. (canceled)

18. A fiber composite component comprising:
a) a fiber material, preferably in the form of a textile layer,
b) a matrix material,
wherein the fiber composite component further comprises
c) a sensor element.

19. The fiber composite component according to claim 18, wherein the fiber composite component has a flexural strength of ≥500 MPa determined according to DIN EN ISO 14125:2011-05.

20. The fiber composite component according to claim 18, wherein the fiber material has, at least partially, preferably completely, a preferably textile surface structure which is selected from the group consisting of laid scrim, woven fabric, nonwoven fabric or mixtures thereof, and/or wherein the fiber material is preferably selected from glass fibers, carbon fibers, basalt fibers, ceramic fibers, steel fibers, polymer fibers, such as synthetic fibers, in particular aramid and nylon fibers, or natural polymer fibers, such as flax, hemp, or protein fibers.

21. The fiber composite component according to claim 18, wherein the fiber composite component has the fiber material in the form of two or more surface structures, preferably in the form of textile layers.

22. The fiber composite component according to claim 21, wherein the sensor element is stitched, adhesively bonded or printed onto at least one of the surface structures with a thread.

23. The fiber composite component according to claim 21, wherein the sensor element is arranged, at least partially, preferably completely, between two surface structures.

24. The fiber composite component according to claim 18, wherein the fiber composite component is plate-shaped, wherein the height of the plate is at least 1 mm, preferably 3 mm.

25. The fiber composite component according to claim 18, wherein the fiber composite component is a body component, preferably an impact protection plate for a battery housing, or part of a battery housing.

26. The fiber composite component according to claim 18, wherein the sensor element has at least two contacting elements for connecting additional elements of a sensor device, in particular an analytical unit and/or a signal output and/or a control system.

27. The fiber composite component according to claim 18, wherein the sensor element is an electrically conductive structure which is insulated from the fiber material.

28. The fiber composite component according to claim 27, wherein the electrically conductive structure consists of a material that has a conductivity under standard conditions of ≥1*10⁶ S/m, preferably 1*10⁷ S/m.

29. The fiber composite component according to claim 18, wherein the fiber material comprises a carbon fiber layer and/or the sensor element is an electrically conductive structure which has an insulating sheath.

30. The fiber composite component according to claim 27, wherein the electrically conductive structure has, at least partially, a profile deviating from a straight profile within the fiber composite component, in particular a meandering profile.

31. The fiber composite component according to claim 27, wherein the electrically conductive structure is selected from the group consisting of electrically conductive wires, electrically conductive polymers, in particular in the form of electrically conductive fibers, electrically conductive conductor tracks, preferably metal wires, particularly preferably copper wires.

32. The fiber composite component according to claim 27, wherein the fiber composite part is designed such that a maximum change in the electrical conductivity of the electrically conductive structure of 10% can be achieved by a non-destructive mechanical loading of the fiber composite component.

33. A system comprising a fiber composite component as defined in claim 18 and an analytical unit by means of which a change in properties of the sensor element, e.g., a change in conductivity, can be determined, wherein preferably fiber composite component and analytical unit are connected to one another via contacting elements.

34. A battery structure comprising a fiber composite component having a sensor element, preferably as defined in claim 18, and a battery housing and/or a battery, wherein the fiber composite component is preferably arranged, in particular fastened, on one of the outer sides of the battery housing or the battery.
